(19) United States
(12) Patent Application Publication
(10) Pub. No.: US 2017/0347671 A1
(43) Pub. Date: Dec. 7, 2017

(54) Glutamic Acid Containing Gluten-Free Dough

(71) Applicant: General Mills, Inc., Minneapolis, MN (US)

(72) Inventors: David J. Domingues, Plymouth, MN (US); Christine O'Connor, Rogers, MN (US); Susan De Werff, Minnetonka, MN (US)

(21) Appl. No.: 15/506,591

(22) PCT Filed: Aug. 27, 2014
(86) PCT No.: PCT/US14/52842

§ 371 Date: Feb. 24, 2017

(51) Int. Cl. A21D 13/066; A21D 10/04; A21D 2/26; A21D 15/02; A21D 2/18

(52) U.S. Cl. CPC A21D 13/066; A21D 15/02; A21D 2/186; A21D 2/188; A21D 2/263; A21D 2/266; A21D 2/183; A21D 10/045; A23V 2002/00; A23V 2250/156; A23V 2250/2131; A23V 2250/5118; A23V 2250/60

(57) ABSTRACT

A packaged refrigerated gluten-free dough composition comprises at least one gluten-free flour source in at least 35% by weight of the composition, at least one starch source in at least 2% by weight of the composition and at least one protein source in about 0.5% to 13% by weight of the composition and at least 17 grams of glutamic acid per 100 grams of the protein, at least one fat source from 4% to 10% by weight of the composition and water from 25% to 35% by weight of the composition. The dough has an average storage modulus ranging from about 45 kPa to about 60 kPa at about 40° F. and an average loss modulus ranging from about 10 kPa to about 20 kPa at about 40° F. after at least 24 hours of storage at about 40° F., and is substantially free of gluten protein.

### BACKGROUND

Gluten is a protein found in a variety of grains including wheat, rye, and barley, with wheat containing the highest levels of gluten when compared to other cereal grains. Although wheat flour is typically referred to as containing gluten, in reality, wheat flour contains two proteins, gliadin and glutenin, which when hydrated combine to fox gluten.

Gluten contributes to the texture and taste of wheat flour-based baked goods such as pizza crusts, cookies, pie crusts, brownies, and breads. Upon hydration, gluten forms a network of fine strands that give the dough structure and the capacity to stretch and/or rise during baking. The elasticity of gluten enables the dough to trap gases, which create open cellular structures upon baking.

Gluten also affects the viscosity of dough. As described above, gluten forms the structure of the dough. The extent of the network of gluten strands impacts whether a mixture is thin and runny, like a batter, or is thick, like a dough. For a pizza crust, for example, wheat flour can make up a substantial amount of the composition.

Some individuals are sensitive or intolerant to gluten. Recently there has been a growing trend to provide gluten-free baked goods. While consumers are demanding gluten-free products, it is very difficult to produce gluten-free products having a similar taste and texture as traditional gluten and/or wheat flour containing products. As described above, gluten provides the structure or framework for traditional baked goods. When wheat flour is replaced with a gluten-free flour such as rice flour, the dough lacks the matrix to create the structure and texture typically associated with comparable gluten containing baked goods. For example, gluten-free dough may not have the same elasticity as a gluten dough, and may be drier and more difficult to handle.

Ready-to-bake refrigerated gluten-free dough are commercially available. These refrigerated dough and baked products may not be as satisfying as the gluten containing products. For example the taste, texture and mouth feel of the baked product may not be as satisfactory as compared to a gluten containing baked product and the baked product may be dry and have a crumbly and/or a gritty texture.

Further, consumers enjoy the modern convenience of gluten-free products which can go directly from the pantry, refrigerator or freezer to the oven or other associated baking appliance without the need for additional preparation steps and/or the addition of ingredients. Particularly, there is demand for refrigerated gluten-free products that can go directly from the refrigerator to the oven or other associated baking appliance.

Refrigerated gluten-free dough add additional challenges including shelf stability, dough handling properties and the inability for consumers to adjust or manipulate the ingredients of the dough. Refrigerated gluten-free products must be capable of being stored under refrigerated conditions for an extended period of time (i.e., at least 75 days, at least 90 days, or for up to 120 days). Furthermore, unlike dry mixes in which the consumer can adjust the amount of certain ingredients added to the dough, the consumer is unable to add or adjust the content of a refrigerated gluten-free dough.

### SUMMARY

The present invention relates to shelf stable, gluten-free refrigerated dough formulations and methods of making these formulations. According to some embodiments, a packaged refrigerated gluten-free dough composition comprises at least one gluten-free flour source in an amount of at least 35% by weight of the composition, at least one starch source in an amount of at least 2% by weight of the composition and at least one protein source in an amount of about 0.5% to about 13% by weight of the composition, wherein the at least one protein source includes at least 17 grams of glutamic acid per 100 grams of the protein. The packaged refrigerated gluten-free dough composition also comprises at least one fat source in an amount from about 4% to about 10% by weight of the composition and water in an amount from about 25% to about 35% by weight of the composition, wherein the dough has an average storage modulus ranging from about 45 kPa to about 60 kPa at about 40 degrees Fahrenheit and an average loss modulus ranging from about 10 kPa to about 20 kPa at about 40 degrees Fahrenheit after 24 hours of storage at about 40 degrees Fahrenheit and wherein the composition is substantially free of gluten protein.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a bar chart providing amino acid composition profiles of various protein sources, according to embodiments of the present invention.

FIG. 2 is a bar chart providing the glutamic acid composition of various protein sources, according to embodiments of the present invention.

FIG. 3 provides the dynamic mechanical spectra of different dough specimens, according to embodiments of the present invention.

FIG. 4 is a bar chart providing percent differences of the loss and storage modulus values between gluten-free dough samples and a gluten-containing dough sample, according to embodiments of the present invention.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

The present invention relates to a gluten-free refrigerated dough or dough composition. In particular, the present invention relates to a gluten-free dough composition comprising a suitable protein source. In some embodiments, the gluten-free dough composition comprises a protein source having a suitable glutamic acid concentration. The gluten-free refrigerated dough resembles, in various embodiments, a gluten containing dough, capable of being stored for a long or extended period time in the refrigerator without the need for hermetic or pressurized sealing (e.g., in a non-pressurized or atmospheric container), and produces a baked product comparable to that obtained with gluten containing refrigerated dough. In some embodiments, the gluten-free refrigerated dough can be packaged in a form that is ready to bake.

In some embodiments, the gluten-free refrigerated dough can include at least one gluten-free flour source, at least one starch source, at least one protein source, at least one fat source, water and additional ingredients such as eggs and/or sugar. Gluten-free refrigerated dough compositions, according to embodiments of the present invention, contains less than 20 ppm gluten or contains 0% by weight of gluten. In some embodiments, gluten content may be determined based on the gliadin component. A suitable method for determining the gluten content of a food product is provided in Association of Analytical Communities (AOAC) Official Method 991.19: Gliadin as a Measure of Gluten in Foods (final action 2001).

In some embodiments, the gluten-free dough may include from about 28% to about 45% liquid ingredients, including fat (i.e., oil and solid shortening) and water, by weight of a dough composition, and from about 37.5% to about 71% dry ingredients, including the gluten-free flour source, starch source, protein source and sugar, by weight of the dough composition.

In various embodiments, it is desirable to produce a gluten-free dough that is comparable in texture and taste to that of a gluten-containing dough. In a gluten-containing dough, gluten contributes to the texture and taste of gluten containing (e.g., wheat flour based) baked goods such as cookies, brownies, and breads. Upon hydration, gluten forms a network of fine strands that give the dough the capacity to stretch and/or rise during baking. The elasticity of gluten enables the dough to trap gases, which creates open cellular structures upon baking. The dough described herein includes a protein source selected to mimic the functionality of a gluten containing mixture such that the resulting baked product has a color, rise, spread, texture, flavor and/or mouth feel similar and/or comparable to a gluten-containing baked product.

Prior to baking, gluten affects the viscosity of dough. As described above, gluten contributes to the structure of the dough. The extent of the network of gluten strands impacts whether a mixture is thin and runny, like a batter, or is thick, like a dough. The dough of the current invention has a rheology similar to that of a gluten containing dough. That is, the dough described herein has a satisfactory viscosity and is sufficiently moist to enable the dough to be rolled or formed into a suitable shape for baking. Further, the dough described herein can be acceptable for commercial production, enabling the dough to be formed in large scale batches, and pumped or extruded into containers for commercial sale. In some embodiments, the dough may be pumped, extruded and/or otherwise transferred to a non-pressurized container (e.g., a container at atmospheric pressure).

In various embodiments, the gluten-free dough composition can include at least one protein source. Suitable amounts for the protein source may be in an amount of about 0.5% to about 13% by weight of the dough composition. Another suitable range includes a protein source in an amount of about 1% to about 4% by weight of the dough composition. Exemplary protein sources include sodium caseinate, whey protein, soy protein, sesame flour (or sesame protein), almond protein and combinations thereof. In some embodiments, the protein source present in the gluten-free dough composition may consist of or consist essentially of at least one member selected from a group consisting of sodium caseinate, whey protein, soy protein, sesame flour (or sesame protein), almond protein and combinations thereof. In some embodiments, the protein source may have a significant effect on producing desirable rheological and texture quality in gluten-free dough.

A protein source can be composed of one or more amino acids. Proteins are created through the polymerization of amino acids, such as alanine (Ala), arginine (Arg), asparagine (Asp), cysteine (Cys), glutamic acid (Glu), glycine (Gly), histidine (His), isoleucine (Iso), leucine (Leu), lysine (Lys), methionine (Met), phenylalanine (Phe), proline (Pro), serine (Ser), threonine (Thr), tyrosine (Tyr), tryptophan (Typ) and valine (Val).

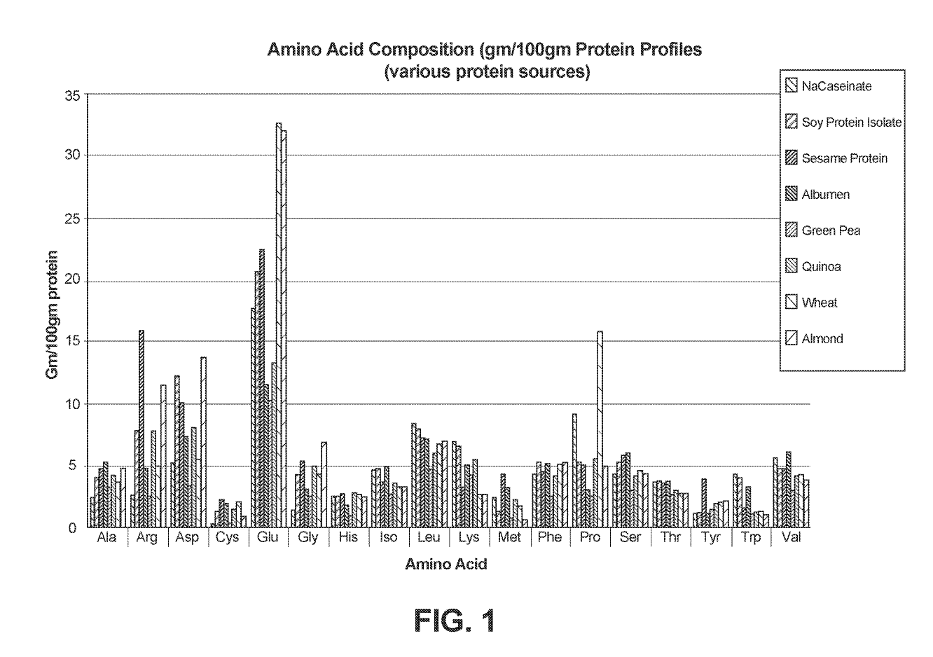

FIG. 1 is a bar chart that provides amino acid composition profiles of various protein sources, which shows the amount (in grams) of an amino acid per every 100 grams (g) of the protein source. As shown, the amino acid composition can vary from one protein source to another. For example, each of the eight protein sources shown in FIG. 1 includes all of the above listed amino acids.

Protein sources may comprise a different amounts and combinations of amino acids. For example, FIG. 1 shows that the amino acids predominately present in almond protein source are glutamic acid (32 g/100 g protein), asparagine (14 g/100 g protein) and arginine (12 g/100 g protein) while the amino acids predominately present in wheat are glutamic acid (33 g/100 g protein), proline (16 g/100 g protein) and leucine (7 g/100 g protein). Furthermore, FIG. 1 shows a general trend of larger amounts of glutamic acid being present in various protein sources when compared to the amount of other amino acids in the protein sources. For example, FIG. 1 shows that almond protein source has 32 g of glutamic acid per every 100 g of the almond protein source and less than 15 g of any another amino acid per 100 g of the almond protein source.

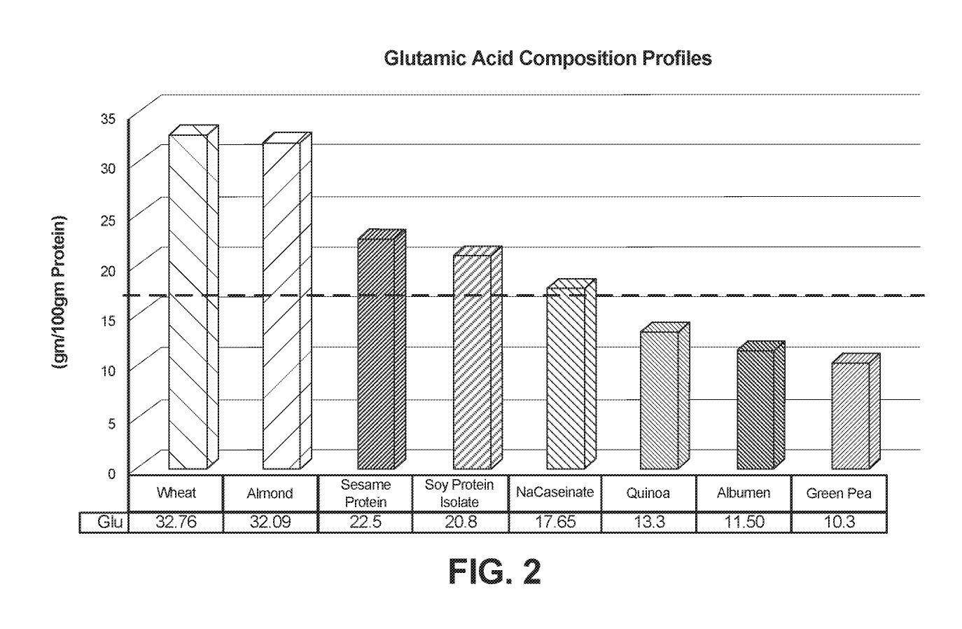

It has surprisingly been found that the glutamic acid content of the protein source affects the suitability of gluten-free dough. Accordingly, a suitable protein or protein source may be identified by determining the glutamic acid content of the protein source. As shown in FIG. 2, the amount of glutamic acid varies amongst various protein sources. For example, a wheat protein source has the largest glutamic acid content (33 g/100 g protein) of all of the listed protein sources in FIG. 2. Furthermore, almond, sesame, soy and sodium caseinate protein sources have larger glutamic acid content per gram than the other proteins such as green pea, albumen and quinoa protein sources, but a lower amount of glutamic acid than the wheat protein source. More specifically, FIG. 2 shows that the sodium caseinate, soy, sesame, almond, and wheat protein sources have a glutamic acid content greater than 17 grams of glutamic acid per 100 grams of the protein source while albumen, green pea and quinoa have a glutamic acid content less than 17 grams of glutamic acid per 100 grams of the protein source.

In some embodiments, the presence of a suitable protein source in a gluten-free dough composition can affect the texture and consistency of the gluten-free dough. In various embodiments, the suitable protein source produces dough that has texture and consistency similar to dough containing wheat gluten. In some embodiments, the gluten-free dough composition includes at least one protein source having at least 17 grams of glutamic acid per 100 grams of the protein source. Exemplary protein sources having at least 17 grams of glutamic acid per 100 grams of the protein source include, but are not limited to, wheat protein, almond protein, sesame protein, soy protein isolate and sodium caseinate protein.

At least one gluten-free flour source is present in the gluten-free dough composition, in various embodiments. The gluten-free flour source may be present in the gluten-free dough composition in an amount of at least 35% by weight of the dough composition, in accordance with embodiments of the present invention. In some embodiments, the gluten-free flour source may be present in an amount from about 35% to about 45% by weight of the dough composition. In some embodiments, the gluten-free flour source may be present in an amount from about 38% to about 42% by weight of the dough composition. The gluten-free flour source may include, consist essentially of or consist of rice flour, sorghum flour, cassava flour, millet flour, quinoa flour, legume flour and combinations thereof. The gluten-free flour source is a substitute for wheat flour and/or other gluten containing flours traditionally used in refrigerated dough.

The gluten-free flour source present in the gluten-free dough composition can include rice flour. Rice flour does not contain either gliadin or glutenin. In some embodiments, the rice flour may be present in amount of at least 35% by weight of the dough composition and more particularly from about 35% to about 45% by weight of the dough composition. In some embodiments, suitable forms of rice flour include short, medium, and long grain white and brown rice flour. For example, in some embodiments, the dough composition may include the medium grain rice flour in an amount from about 38% to about 42% by weight of the dough composition.

The gluten-free starch source may be present in the gluten-free dough composition in an amount of at least 2% by weight of the dough composition, in accordance with embodiments of the present invention. In some embodiments, the gluten-free starch source may be present in an amount from about 2% to about 6% by weight of the dough. In some embodiments, the gluten-free starch source may be present in an amount from about 3% to about 5% by weight of the dough composition. The gluten-free starch source may include, consist essentially of or consist of potato starch, cassava starch (also referred to as tapioca starch), corn starch and combinations thereof.

The gluten-free flour source can include sorghum flour. In some embodiments, sorghum flour may be present in amount of at least 35% by weight of the dough composition. In some embodiments, the inclusion of sorghum flour may provide more body and better mouth feel to the overall texture of the dough. Sorghum flour has a bland flavor profile. In some embodiments, sorghum flour may be used in combination with rice flour as rice flour can cause grittiness if included in the dough at too high an amount.

The gluten-free flour source may include millet flour, in various embodiments. In some embodiments, the millet flour may be present in amount of at least 35% by weight of the dough composition and more particularly from about 35% to about 45% by weight of the dough composition. The inclusion of millet flour may provide a suitable substitute for rice flour. In some embodiments, a dough composition including millet flour may prevent the dough from being gritty or having off flavors caused by other substitutes. A dough composition having too much millet flour may be too sweet and have a “whole wheat” flavor.

The gluten-free flour source can include other flours, such as cassava flour, quinoa, legume flour in addition to or in combination with one or more of the above described flours.

To maintain a desired moisture level and spread characteristics, the gluten-free dough may include at least one starch source in an amount of at least 2% starch by weight of the dough composition. For example, suitable dough may include the starch source from about 2% to about 6% by weight of the dough composition and more particularly from about 3% to 5% by weight of the dough composition.

Suitable starch sources include potato starch, tapioca starch, corn starch and combinations thereof. The starch source may provide additional structural and textural properties that flour source alone cannot provide. For example, tapioca, which is the starch extracted from the root of a cassava plant, may help provide a smoother texture dough. In some embodiments, the potato, tapioca and/or corn starch may be native or unmodified starch(s). In other embodiments, the potato, tapioca and/or corn starch may be modified starch(s). Modified starches can be prepared by physically, enzymatically or chemically treating the native starch to change the properties of the starch. The inclusion of potato, tapioca starch and/or corn starch into the gluten-free dough may provide a dough texture similar to wheat based dough without creating off-flavors.

A combination of the flour, protein and starch sources can provide a gluten-free refrigerated dough having the taste, texture and rheology similar to that of gluten containing dough. The described flour, protein and starch sources also provide a gluten-free refrigerated dough having organoleptic properties similar to that of a gluten-based dough.

The gluten-free dough composition can include at least one fat source. In some embodiments, the gluten-free dough composition can include at least one fat source in an amount of about 2% to about 7% by weight of the composition. In some embodiments, the fat source may affect the spread of the dough during baking. For example, in some embodiments, the inclusion of less than 4% fat source may result in a baked product that has an insufficient amount of spread, is difficult to handle, and that is dry, while too much fat source may result in a baked product that is undesirably soft as compared to the typical gluten containing dough.

The fat source includes at least one shortening in accordance with embodiments of the invention. Animal or vegetable based natural shortenings can be used, as can synthetic shortenings. Shortening is generally comprised of triglycerides, fats and fatty oils that are made predominantly from tri-esters of glycerol with fatty acids. Suitable shortenings may include cottonseed oil, nut oil, soybean oil, sunflower oil, rapeseed oil, sesame oil, olive oil, corn oil, safflower oil, palm oil, palm kernel oil, coconut oil, and combinations thereof. In some embodiments, the shortening may be hydrogenated shortening. The shortening may have beneficial effects on the volume, grain and texture of the dough, as well as the texture, mouth feel and other organoleptic properties of the baked product. In some embodiments, the gluten-free dough composition includes shortening in an amount from about 3.5% to about 7.5% by weight of the composition.

In some embodiments, the fat source includes at least one oil. In some embodiments, the oil is a virgin olive oil or an extra virgin olive oil. A variety of different oils may be used, including palm oil, coconut oil, cottonseed oil, peanut oil, olive oil, sunflower seed oil, sesame seed oil, corn oil, safflower oil, poppy seed oil, soybean oil, and combinations thereof. In some embodiments, the oil may be present in an amount ranging from about 2% to about 4% by weight of the dough composition. In some embodiments, the oil including extra virgin olive oil may be present in an amount of about 3.1% by weight of the dough composition.

The refrigerated gluten-free dough may further include water in an amount ranging from about 25% by weight to about 34% by weight of the refrigerated gluten-free dough composition. In some embodiments, the dough includes water ranging from about 26% by weight to about 30% by weight. In some embodiments, the dough includes water ranging from about 30% by weight to about 33% by weight of the composition. The water content affects the texture and consistency of the refrigerated gluten-free dough, as well as the water activity. In some embodiments, it is desired to produce a refrigerated gluten-free dough that has the same texture and consistency as a typical gluten containing dough, i.e, a dough that is crust-formable and that is sufficiently moist to enable the dough to be rolled flat for baking without crumbling.

The gluten-free dough composition may include at least one sugar. Useful sugars include saccharides such as monosaccharides and disaccharides. Monosaccharides typically have 5 or 6 carbon atoms, and have the general empirical formula Cₙ(H₂O)ₙ. Disaccharides consist of two monosaccharides joined together with the concomitant loss of a water molecule. Illustrative but non-limiting examples of suitable sugars include pentoses such as fructose, xylose, arabinose, glucose, galactose, amylose, fructose, sorbose, lactose, maltose, dextrose, sucrose, maltodextrins, high fructose corn syrup (HFCS), molasses, rice syrup, white sugar and brown sugar. Suitable amounts of sugar include about 5% to about 7% weight of the composition. For example, in some embodiments, the refrigerated gluten-free dough composition may include sugars, such as brown or white sugar or a combination thereof, at about 5% by weight of the composition.

In some embodiments, the sucrose source may affect the color and flavor (i.e., sweetness) of the baked product. For example, in some embodiments, the inclusion of brown sugar may produce a darker baked product as compared to a product in which all or a portion of the brown sugar is substituted with granulated white sugar. Sucrose is present in the refrigerated gluten-free dough to provide sweetness and may affect the spread of the dough during baking.

Sugar may lower the water activity, a_{w}, of the dough. Water activity is a measure of the equilibrated water vapor pressure generated by the product divided by the vapor pressure of pure water at the same temperature as shown in Formula (1).

a_{w}=p/p₀ (1)

where p is the vapor pressure of water in the substance, and p₀ is the vapor pressure of pure water at the same temperature.

The refrigerated gluten-free dough may include various chemical leavening agents that make up a chemical leavening system. A chemical leavening system may include an acid and a base that can react to form carbon dioxide. Suitable agents of leavening systems may include baking soda (sodium bicarbonate or potassium bicarbonate), monocalcium phosphate monohydrate (MCP), monocalcium phosphate anhydrous (AMCP), sodium acid pyrophosphate (SAPP), sodium aluminum phosphate (SALP), dicalcium phosphate dihydrate (DPD), dicalcium phosphate (DCP), sodium aluminum sulfate (SAS), glucono-deltalactone (GDL), potassium hydrogen tartrate (cream of tartar), and the like.

Baking soda is an example of a leavening agent. More specifically, baking soda is a leavening base and is the primary source of carbon dioxide in many chemical leavening systems. This compound is stable and relatively inexpensive to produce. Baking soda can be used in either an encapsulated form or in a non-encapsulated form. Use of an encapsulated baking soda delays the onset of the leavening reaction as the encapsulating material must first be dissolved before the leavening reaction can occur. In some embodiments, the dough may include a leavening acid in an amount sufficient to neutralize the added soda. In some embodiments, the refrigerated gluten-free dough may include from about 0.5% to about 1% of a leavening agent, such as baking soda and/or SALP, by weight.

A pre-reaction of the chemical leavening agent may be limited by including an encapsultated sodium bicarbonate (referred to hereinafter as “e-soda”) and/or an acid. In particular, e-soda may be used to limit a pre-reaction of the bicarbonate during storage and processing of the dough. The pre-reaction of the chemical leavening agent may also include the use of a heat activated acid, such as SALP. Specifically, SALP may be used with e-soda to further limit the pre-reaction of the leavening agent. In some embodiments, the baking soda comprises an e-soda that includes about 60% sodium bicarbonate and about 40% encapsulating hydrogenated vegetable oil coating, wherein the hydrogenated vegetable oil coating has a melt point of at least 100° F. Limiting the pre-reaction helps to minimize or prevent the release of carbon dioxide gas prior to baking of the dough, which in turn, reduces or eliminates unwanted expansion of the dough and ensures optimal rise of the dough upon baking.

Hydrocolloids or gums, can be added to the dough formulation to give structure to the dough and bind ingredients (i.e., to create a suitable matrix within the dough in the absence of gluten). For example, hydrocolloids may be added to improve the rheology and crumb texture by stabilizing small air cells within the dough and bind to moisture. Hydrocolloids are hydrophilic polymers that contain hydroxyl groups and may be polyelectrolytes. Suitable hydrocolloids may be of vegetable, animal, microbial or synthetic origin. Suitable hydrocolloids include xanthan gum, guar gum, locust bean gum, carrageenan gum, hydroxypropyl methylcellulose (HPMC), propylene glycol alginate (PGA), carboxymethyl cellulose, konjac flour, pectin, agarose, alginate, agarose, beta glucan and combinations thereof. In some embodiments, hydrocolloids or gums may be present in an amount from about 0.5% to about 2% by weight of the dough composition. In some embodiments, hydrocolloids or gums may be present in an amount of about 0.14% by weight of the dough composition.

In some embodiments, the refrigerated gluten-free dough may include egg solids. Suitable sources of egg solids include whole eggs (albumen and yolk) and dried whole eggs. The egg solids also contribute to structure to the dough. More specifically, the proteins of the eggs solids provide a matrix or bind the ingredients together to form a suitable dough. In some embodiments, dried whole egg may be present in an amount from about 2% to about 4% by weight of the composition. In some embodiments, dried whole egg may be present in an amount of about 3% by weight of the composition.

Egg whites and dried egg whites may also be used in addition to or as an alternative to egg solids. In some embodiments, it has been found that the inclusion of eggs and/or egg whites may reduce oil migration in the dough. In some embodiments, dried egg whites may have impact on the overall color and appearance of the dough, as the egg yolks can yellow the dough. In some embodiments, if dried eggs are used, it may be necessary to increase the percentage of egg solids as compared to the percentage of egg white solids.

In some embodiments, the refrigerated gluten-free dough may include one or more natural and/or synthetic bread flavors. In some embodiments, the refrigerated gluten-free dough may include a bread flavoring agent containing ethanol. The ethanol may also provide microbiological benefits. The ethanol may be present in an amount ranging from about 1% by weight to about 2% by weight of the composition.

In some embodiments, the refrigerated gluten-free dough may include one or more antimycotic agent(s) to enhance microbial stability. Useful agents include sorbic acid and its derivatives such as sodium or potassium sorbate, propionic acid and its derivatives, vinegar, sodium diacetate, monocalcium phosphate, lactic acid, citric acid and the like. These agents are present in an amount effective to inhibit the growth of undesired yeast and/or molds, typically in amount from about 0.1% to about 0.2% by weight of the dough. Too little will not provide sufficient antimycotic effect, while too much can impart an off taste to the dough. Additionally, the pH of the dough may be adjusted to ensure that enough of the added organic acid preservatives (e.g., sorbate and propionate) are in an undissociated antimycotic form generally at a pH range of about 6.5 to about 6.75.

In addition to the foregoing, other ingredients known to those of skill in the art can be included in the compositions to give a variety of desired properties, flavors and/or textures. Examples of these ingredients include flavoring and coloring agents, flavors, spices, acids, and the like.

As discussed herein, the texture and consistency of the gluten-free dough is similar to that of gluten dough. The texture and consistency of dough may be evaluated using a rheological test, such as a dynamic mechanical analysis. For example, a dynamic mechanical analysis may be used to study materials exhibiting viscoelastic behavior, which is behavior that includes both elastic solids and Newtonian fluids characteristics.

The dynamic mechanical analysis may include measuring a storage modulus (G′), also referred to as an elastic modulus, and a loss modulus (G), also referred to as a viscous modulus. The storage modulus is a measure of the stored energy, e.g., an elastic response of a material, while the loss modulus is a measure of heat dissipation, e.g., a viscous response of the material. The viscoelastic properties of a material may be observed by applying a temperature-based sweep or a frequency-based sweep test. In a temperature-based sweep test, modulus values of a sample are measured at a constant frequency over a given temperature range. In a frequency-based sweep test, modulus values of a sample are measured at a constant temperature over a given frequency range.

A suitable gluten-free refrigerated dough may have an average storage modulus from about 40 kPa to about 80 kPa at about 40° F. (4° C.) and after 24 hours storage at about 40° F. (4° C.). A suitable range of average storage modulus of the gluten-free refrigerated dough includes a range from about 45 kPa to about 60 kPa at about at about 40° F. (4° C.) and after 24 hours storage at about 40° F. (4° C.), in some embodiments.

Suitable ranges for an average loss modulus of a gluten-free refrigerated dough can include a range from about 10 kPa to about 20 kPa, or, alternatively, a range from about 13 kPa to about 18 kPa, at about 40° F. (4° C.) and after 24 hours storage at about 40° F. (4° C.) in accordance with some embodiments.

An exemplary gluten-free flour dough composition is provided in Table 1. All components in Table 1 are provided as weight percent of the dough composition. In various embodiments, the dough composition provided in Table 1 can be used in any type of dough application to produce a baked good. For example, the dough composition may be applied in a baking application to produce pizza crusts, cookies, pie crusts, brownies, and breads, in some embodiments.

TABLE 1
Refrigerated gluten-free dough composition

| | First Range | Second Range |
|---|---|---|
| | (% by weight of | (% by |
| Components | composition) | weight of composition) |
| Gluten-free flour source | ≧35% | 35-45% |
| Starch source | ≧2% | 2-6% |
| Protein source | 0.5-13% | 1-5% |
| (17 grams glutamic acid/ | | |
| 100 grams protein) | | |
| fat source | 4-11.5% | 6-10% |
| water | 25-35% | 25-30% |

The refrigerated gluten-free dough may be prepared by combining and stirring the ingredients in a standard mixer, such as a Hobart or a Sigma mixer, with an appropriate mixing element, e.g., a hook for dough or a paddle for batters. In some embodiments, the mixing of the dough may be carried out under chilled conditions. For example, the dough may be mixed using chilled water or a chilled jacketed mixing bowl such that the final dough temperature after mixing is at about 65° F. to 68° F. (18-20° C.). In some embodiments, the gluten-free dough can be made in a three-stage process. In the first stage, the first stage ingredients, such as but not limited to at about 40° F. (4° C.) and after 24 hours storage at about 40° F. (4° C.), can be blended together. In the second stage, ingredients such as sugar, salt, preservatives and leavening agents may be added to the first stage ingredients and mixed together for an optimum time. In the third stage, additional ingredients such as the encapsulated sodium bicarbonate may be added to the mixture of first and second stage ingredients and mixed together.

In some embodiments, leavening agents, salt and sugar are added in later stages of mixing to initially hydrate farinaceous components, such as flour, protein, starch and hydrocolloids. After mixing is complete, the dough can be pumped into a filler, and the dough can be placed in suitable containers, such as by extrusion. The containers can be of any desired shape, such as a tub with snap on lid made of a material such as polypropylene, linear low density polypropylene, or other suitable material. In some embodiments, the containers need not be hermetically sealed or pressurized to provide the dough with acceptable microbial stability under refrigeration temperatures. A shrink band may be included to provide evidence of tampering.

In some embodiments, the dough may be workable under normal refrigeration conditions, generally about 35-55° F. (1-13° C.). By “workable”, it is meant that the consumer can readily remove the dough from the container or can, and can flatten the dough into a desired form and shape. In some embodiments, the dough may be sold in a form that is suitable for use as provided. For example, the refrigerated dough may simply be removed from the package, optionally rolled, and then baked under normal conditions, e.g., in a 350-375° F. (176-191° C.) oven for a sufficient amount of time to fully cook the product. In some embodiments, the dough may retain its leavening properties and microbial stability for at least about 90 days under refrigerated conditions. If desired, the dough may be frozen for even longer term storage stability.

In some embodiments, the dough may be shelf stable for at least about 90 days under refrigerated conditions. By shelf stable it is meant that the dough remains microbial-safe. Shelf stable also means that the dough maintains a desired texture, appearance and taste that produces a baked product having a desired taste, texture and mouth feel. For example, in some embodiments, the shelf stable dough described herein does not experience or experiences very little oil migration. As described herein, a combination of the disclosed amounts of oil, shortening and egg may reduce and/or eliminate oil migration (also referred to as oiling out).

In some embodiments, the dough bakes into a baked product that has a taste, texture, and mouth feel similar to that of a gluten containing baked product.

An exemplary gluten-free flour dough composition for producing gluten-free pizza dough is provided in Table 2. The components listed in Table 2 are provided as weight percent of the dough composition.

TABLE 2
Refrigerated gluten-free pizza dough composition

| | First Range | |
|---|---|---|
| | (% by weight | Second Range |
| Components | of composition) | (% by weight of composition) |
| Gluten-free flour | 35-45% | 40-45% |
| source | | |
| Starch source | 2-6% | 4-6% |
| Protein source | 1-4% | 1-3% |
| (17 grams glutamic | | |
| acid/100 | | |
| grams protein) | | |
| Oil | 2-4% | 2.5-3.5% |
| Shortening | 3.5-7.5% | 5-7% |
| Water | 25-35% | 25-35% |
| Sugar | 5-7% | 5-6% |
| Dried whole egg | 5% | 2-4% |
| Leavening agent | 0.5-1% | 1.5-2.5% |

In various embodiments, an exemplary refrigerated gluten-free pizza dough composition can include a flour source that is a combination of two or more flour sources. For example, the gluten-free pizza dough composition can include a flour mixture that comprises the rice flour source and the sorghum flour source. In some embodiments, the flour mixture includes two or more flour sources, wherein one flour source is in a larger amount than another flour source. For example, the flour mixture can include rice and sorghum flour wherein the rice flour is present in a greater amount than the sorghum flour. The gluten-free pizza dough composition can optionally include suitable amounts of water, baking powder, hydrocolloids, seasoning, flavoring agents and preservatives.

The gluten-free pizza dough may be prepared by combining the ingredients by stirring in a standard mixer, such as a Hobart or a Sigma mixer. In some embodiments, the mixing of the gluten-free pizza dough may be carried out under chilled conditions. For example, the dough may be mixed using chilled water or a chilled jacketed mixing bowl such that the final dough temperature after mixing is at about 65° F. to 68° F. (18-20° C.). The gluten-free dough can be made in a four-step process. In the first step, all of the liquids are added to the mixer. In the second step, the flour source, starch source, protein source, fat source, water and optionally any hydrocolloids, preservatives and flavoring agents, are added to the liquid and slowly mixed for 30 seconds and then quickly mixed for 60 seconds. In the third step, sugar, salt, preservatives and leavening agents are added to the first stage ingredients and are mixed together slowly for 30 seconds and then quickly for 60 seconds. After mixing is complete, the pizza dough can be placed in suitable containers, as described previously herein. For example, 400 g of the pizza dough may be placed into a tub container, in some embodiments.

In some embodiments, the gluten-free pizza dough described herein is workable under normal refrigeration conditions, generally about 35-55° F. (1-13° C.). In some embodiments, the pizza dough may be sold in a form that is suitable for use as provided. For example, the refrigerated pizza dough may simply be removed from the package, optionally rolled, and then baked under normal conditions, e.g., in a 350-375° F. (176-191° C.) oven for a sufficient amount of time to fully cook the product. The pizza dough will retain its leavening properties and microbial stability for at least about 90 days under refrigerated conditions. If desired, the pizza dough may be frozen for even longer term storage stability.

In various embodiments, the pizza dough bakes into a baked product that has a taste, texture, and mouth feel similar to that of a gluten-containing baked pizza product.

### Examples

The present invention is more particularly described in the following examples that are intended as illustrations only, since numerous modifications and variations within the scope of the present invention will be apparent to those of skill in the art. Unless otherwise noted, all parts, percentages, and ratios reported in the following examples are on a weight basis.

### Formation of Gluten-Free, Refrigerated Dough

A variety of gluten-free refrigerated dough and a control gluten-based dough were formed and tested. Each dough was prepared by combining the ingredients by stirring in a standard mixer such as a Sigma or a Hobart mixer using chilled water and/or a chilled jacketed mixer resulting in a finished mixed dough temperature in the range of about 65° F. (18° C.) to about 68° F. (20° C.). Each dough sample was made in a three stage process. In the first stage, all of the flour source, starch source, protein source, fat source, water and optionally any hydrocolloids, preservatives and flavoring agents were blended together. In the second stage, the sugar, salt, preservatives and leavening agents were added to the first stage ingredient and were mixed together for an optimum time. In the third stage, the e-soda was added to the mixture and mixed together for an optimum time.

### Rheological Analysis (Frequency-Based Sweep Test)

The effect of protein sources in various dough samples were evaluated by observing and comparing the rheological behavior of the dough samples. The rheological behavior of various dough samples were analyzed by measuring and plotting the storage moduli (G′) and the loss moduli (G″) over a frequency range of 0.10 to 10 Hertz (Hz). The rheological behavior of the samples was measured using a frequency-based stress sweep test at a temperature of 40° F. (4° C.).

All dough samples were stored at 40° F. (4° C.) for at least 24 hours and were tested at 40° F. (4° C.).

The rheological behavior of each dough sample was evaluated using an AR G2 controlled stress rheometer available from TA Instruments, New Castle, Del., USA. The rheometer was configured with a 40 mm diameter analysis plate parallel to a fixed plate with a 1.5 mm separation gap. Each sample was placed in a measurement cell of the rheometer between the two plates and allowed to stabilize in the cell for 5 minutes. The temperature within the cell during testing was controlled using a Peltier temperature controller.

During the stress sweep test, the top plate was rotated with an oscillatory stress sweep of 1.0×10⁻³−20 Pa at a frequency of 1 Hz frequency to determine the linear viscoelastic region of each sample. The test was performed with a frequency-based stress sweep from 0.01 to 10 Hz at a constant oscillatory stress within the linear viscoelastic range at a constant temperature of 40° F. (4° C.).

### Formulations of Control Sample and Examples A-D

Table 3 provides the formulations of Control Sample and Examples A, B, C and D.

Examples A and B each include a protein source having at least 17 grams of glutamic acid per 100 grams of the protein source. In Example A, the protein source is sodium caseinate; Example B the protein source is soy protein.

Example C, as shown in the table below, used a protein source having less than 17 grams of glutamic acid per 100 grams of the protein source. In Example C, the protein source was albumen.

Example D was a gluten-free dough composition having no additional protein source.

TABLE 3
Control and Example A-D Formulations

| | Control | | | | |
|---|---|---|---|---|---|
| | Sample | Example A | Example B | Example C | Example D |
| | Weight % | Weight % | Weight % | Weight % | Weight % |
| | (of total | (of total | (of total | (of total | (of total |
| Ingredient | composition) | composition) | composition) | composition) | composition) |
| Hard Red Winter | 48.36 | | | | |
| Flour | | | | | |
| Sodium caseinate | — | 2.93 | — | — | — |
| protein | | | | | |
| Soy protein | — | — | 2.97 | — | — |
| Albumen protein | — | — | — | 3.22 | — |
| Rice flour (medium | — | 41.34 | 41.30 | 41.08 | 44.01 |
| grain) | | | | | |
| potato starch | — | 4.10 | 4.10 | 4.07 | 4.36 |
| HPMC | 0.14 | 0.14 | 0.14 | 0.14 | 0.14 |
| PGA | 0.26 | 0.26 | 0.26 | 0.26 | 0.26 |
| Sodium propionate | 0.10 | 0.10 | 0.10 | 0.10 | 0.10 |
| Potassium sorbate | 0.10 | 0.10 | 0.10 | 0.10 | 0.10 |
| Water | 31.68 | 31.68 | 31.68 | 31.68 | 31.68 |
| Extra virgin olive oil | 3.11 | 3.11 | 3.11 | 3.11 | 3.11 |
| Artificial flavorings | 1.81 | 1.81 | 1.81 | 1.81 | 1.81 |
| Shortening | 4.47 | 4.47 | 4.47 | 4.47 | 4.47 |
| SALP | 0.69 | 0.69 | 0.69 | 0.69 | 0.69 |
| Salt medium fine | 1.70 | 1.70 | 1.70 | 1.70 | 1.70 |
| filled | | | | | |
| Potassium chloride | 0.51 | 0.51 | 0.51 | 0.51 | 0.51 |
| Sugar | 3.08 | 3.08 | 3.08 | 3.08 | 3.08 |
| Dextrose medium | 3.08 | 3.08 | 3.08 | 3.08 | 3.08 |
| E-soda | 0.91 | 0.91 | 0.91 | 0.91 | 0.91 |

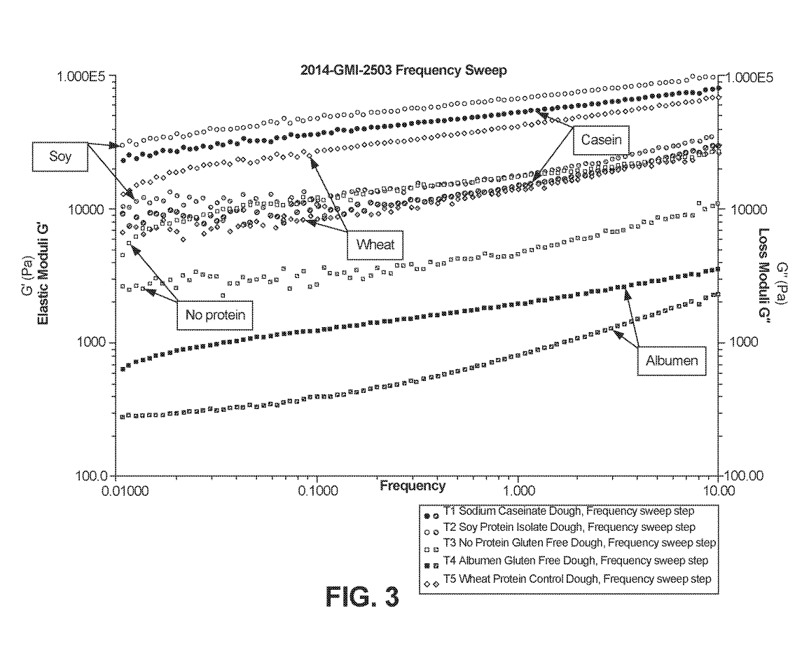

Examples A-D were subjected to the Rheological Analysis (Frequency-based sweep test), as described previously herein. The rheological analysis results are provided in Table 4 and in FIG. 3, wherein Table 4 provides average storage and loss moduli (in kPa) of Examples A-D over a frequency range of 0.01 to 10 Hz and FIG. 3 provides dynamic mechanical spectra of Examples A-D during the stress sweep test. The stress sweep test graph shown in FIG. 3 provides storage moduli (G′) on the left margin and the loss moduli (G″) on the right margin for Examples A-D over a range of frequency from 0.01 to 10 Hz.

TABLE 4
Rheological Test Results

| | Average Storage | Average Loss |
|---|---|---|
| | Modulus (G′) | Modulus (G″) |
| Example | (kPa) | (kPa) |
| Control | 36.8 | 13.0 |
| A | 46.7 | 14.1 |
| B | 59.5 | 17.3 |
| C | 1.75 | 0.7 |
| D | 15.2 | 47.3 |

In comparing Examples A and B to the Control, it can be seen that gluten-free dough compositions that include sodium caseinate or soy protein as a protein source have average storage and loss moduli that are comparable to the wheat-based dough.

In comparing Example C to the Control, it can be seen that a gluten-free dough composition that includes albumen as a protein source has a storage modulus and loss modulus that that are significantly lower than the wheat-based dough.

In comparing Example D to the Control, it can be seen that a gluten-free dough composition having no protein source has a storage modulus and loss modulus that that are significantly lower than the wheat-based dough, but higher than the gluten-free dough composition that includes albumen (i.e., Example C).

The results of the rheological analysis demonstrate that gluten-free dough that include a protein source containing at least 17 grams of glutamic acid per 100 grams of the protein (Examples A and B) rheologically behave similar to a gluten-containing dough (Control). Surprisingly, in contrast, the results also demonstrate that gluten-free dough compositions that include a protein source having less than 17 grams of glutamic acid per 100 grams of the protein (Example C) yield a dough composition with both a lower storage modulus value and a lower loss modulus value when compared to the gluten-containing dough composition. Furthermore, gluten-free dough compositions that include a protein source with less than 17 grams of glutamic acid per 100 grams of the protein perform poorer than the dough composition that included no additional protein source (Example D).

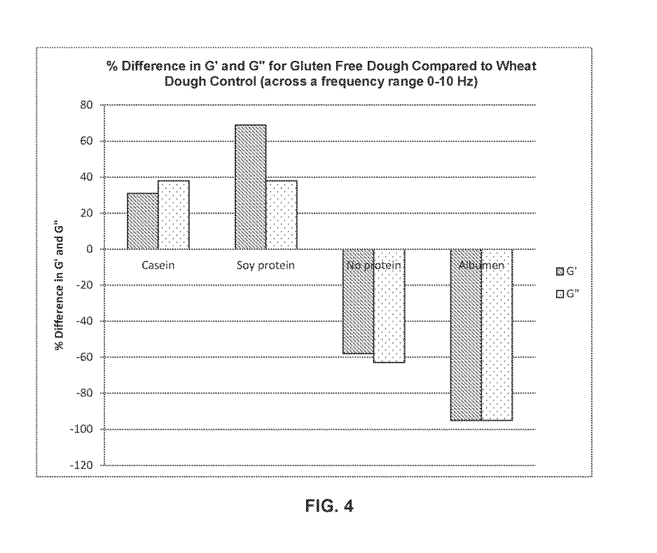

FIG. 4 is a bar chart that provides percent differences of the loss modulus and storage modulus of the gluten-free dough samples (Examples A-D) in comparison to the gluten-containing dough (Control). Interestingly, the gluten-free dough compositions with high-glutamic acid content, e.g., compositions containing equal to or greater than 17 grams of glutamic acid per 100 grams of the protein (Examples A and B), yielded storage and loss moduli greater than the storage and loss moduli of the gluten-containing sample (Control). In contrast, the gluten-free dough compositions with low-glutamic acid content, e.g., compositions comprising a protein source having less than 17 grams of glutamic acid per 100 grams of the protein (Example C) had storage and loss moduli less than the storage and loss moduli of the gluten-containing sample (Control). As shown in FIG. 4, the percent difference for high-glutamic acid content dough (Examples A and B) were positive percentage values while the low-glutamic acid content dough (Examples C and D) were negative percentage values.

Accordingly, as discussed above, the results of the rheological analysis demonstrate that protein source selection based on the glutamic acid content per weight of the protein can significantly affect the rheological behavior of gluten-free dough.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

1. A packaged refrigerated gluten-free dough composition comprising:
at least one gluten-free flour source in an amount of at least 35% by weight of the composition;
at least one starch source in an amount of at least 2% by weight of the composition; and
at least one protein source in an amount of about 0.5% to about 13% by weight of the composition, wherein the at least one protein source includes at least 17 grams of glutamic acid per 100 grams of the protein source;
at least one fat source in an amount from about 4% to about 10% by weight of the composition; and
water in an amount from about 25% to about 35% by weight of the composition;
wherein the dough has an average storage modulus ranging from about 45 kPa to about 60 kPa and an average loss modulus ranging from about 10 kPa to about 20 kPa at about 40 degrees Fahrenheit after 24 hours of storage at about 40 degrees Fahrenheit and wherein the composition is substantially free of gluten protein.

2. The composition of claim 1, wherein the at least one protein source consists of at least one member selected from a group consisting of sodium caseinate, whey protein, soy protein, sesame flour, almond protein and combinations thereof.

3. The composition of claim 1, wherein the at least one gluten-free flour source comprises of at least one member selected from the group consisting of rice flour, sorghum flour, cassava flour, millet flour, quinoa flour, legume flour and combinations thereof.

4. The composition of claim 1, wherein the at least one starch source comprises at least one member selected from the group consisting of potato starch, cassava starch, corn starch and combinations thereof.

5. The composition of claim 1, wherein the composition contains less than 20 ppm gluten.

6. The composition of claim 1, wherein the composition contains 0% by weight of gluten.

7. The composition of claim 1, and further comprising at least one hydrocolloid.

8. The composition of claim 7, wherein the at least one hydrocolloid comprises at least one member selected from the group consisting of propylene glycol alginate (PGA), hydroxyl propyl methyl cellulose (HPMC), carboxymethyl cellulose, konjac flour, xanthan gum, pectin, agarose, alginate, carrageenan, guar gum, locust bean gum, agarose, beta glucan and combinations thereof.

9. The composition of claim 1, further comprising:
the at least one gluten-free flour source in an amount from about 35% to about 45% by weight of the composition, and at least one starch source in an amount from about 2% to about 6% by weight of composition;
the at least one protein source in an amount of about 1% to about 4% by weight of the composition, wherein the at least one protein source includes at least 17 grams of glutamic acid per 100 grams of the protein source;
the at least one fat source comprising:
at least one oil in an amount from about 2% to about 4% by weight of the composition;
shortening in an amount from about 3.5% to about 7.5% by weight of the composition;
at least one sugar in an amount of about 5% to about 7% weight composition; and
at least one leavening agent in an amount of about 0.5% to about 1% soda.

10. The composition of claim 1, and further comprising a grain rice flour in an amount of about 38% to about 42% by weight composition and a potato starch in an amount of about 3% to about 5% by weight composition.

11. The composition of claim 9, wherein the at least one oil is an extra virgin olive oil.

12. The composition of claim 9, wherein the sugar comprises dextrose, fructose, sucrose and/or combinations thereof.

13. The composition of claim 9, wherein the leavening agent comprises an encapsulated soda that includes about 60% soda and about 40% encapsulating hydrogenated vegetable oil coating, wherein the encapsulated oil has a melt point of at least 100° F.

14. The composition of claim 9, wherein the one leavening agent is a leavening acid that is in an amount sufficient to neutralize the added soda.

15. The composition of claim 14, wherein the leavening acid comprises a sodium aluminum phosphate.

16. The composition of claim 9, and further comprising dried whole eggs in an amount of about 2% to about 4% by weight of composition.
